(19) United States
(12) Patent Application Publication
(10) Pub. No.: US 2025/0086529 A1
(43) Pub. Date: Mar. 13, 2025

(54) METHOD FOR CALCULATING CARBON FOOTPRINT OF LEATHER CHEMICAL MATERIAL

(71) Applicants: SICHUAN UNIVERSITY, Chengdu City (CN); Sichuan Chuangzhiweiye Technology Co., Ltd., Chengdu City (CN)

(72) Inventors: Jianfei ZHOU, Chengdu City (CN); Wei LIN, Chengdu City (CN); Qianchuan ZHOU, Chengdu City (CN); Chunhua WANG, Chengdu City (CN); Bi SHI, Chengdu City (CN); Youcheng TANG, Chengdu City (CN); Hexiang DONG, Chengdu City (CN)

(73) Assignees: SICHUAN UNIVERSITY, Chengdu City (CN); Sichuan Chuangzhiweiye Technology Co., Ltd., Chengdu City (CN)

(21) Appl. No.: 18/829,172

(22) Filed: Sep. 9, 2024

(30) Foreign Application Priority Data
Sep. 8, 2023 (CN) 202311157431.4

(51) Int. Cl. G06Q 10/063; G06F 17/11; G06Q 50/04

(52) U.S. Cl. CPC G06Q 10/063; G06F 17/11; G06Q 50/04

(57) ABSTRACT

Some embodiments of the disclosure provide methods for calculating carbon footprints of leather chemical materials. In some examples, the method includes: determining a calculation range of a carbon footprint of a leather chemical material in a life cycle as “cradle to gate”; determining a system boundary, a functional unit, and cut-off criteria for the carbon footprint of the leather chemical material in the life cycle; dividing the carbon footprint into a raw chemical obtaining process, a production process of the leather chemical material, and a waste disposal process within the system boundary; determining a carbon footprint calculation model for the leather chemical material according to resource consumption and environmental emission of each process; collecting and determining a quantity and a value required by each parameter in the carbon footprint calculation model; and calculating the carbon footprint of the leather chemical material using the carbon footprint calculation model.

### CROSS REFERENCE TO RELATED APPLICATIONS

This application claims priority to Chinese patent application number 202311157431.4, filed on Sep. 8, 2023, the disclosure of which is incorporated by reference herein in its entirety.

### FIELD OF THE DISCLOSURE

The disclosure relates generally to the field of leather making. More specifically, the disclosure relates to methods for calculating carbon footprints of leather chemical materials.

### BACKGROUND

Due to the rapid development of human societies, an increasing amount of greenhouse gas has been emitted to the atmosphere. The problem of global warming has raised concern of various countries and organizations in the world. Promoted by the global environment and relevant policies of China, there is an urgent need for use of a correct carbon footprint calculation method in various industries to establish a sound and complete carbon footprint calculation system.

The leather making industry, as an important livelihood industry and export-oriented industry of China, plays an essential role all over the world. Since carbon footprint calculation has been developed for a long time and has become highly mature abroad and carbon footprint calculation has started relatively late in China, an environmental protection barrier established with respect to carbon footprint in international trade will have a great influence on leather export in the near future. For example, it is stipulated in the battery law newly promulgated by the European Union that all imported batteries must be provided with carbon emission labels. Therefore, a life circle assessment method is used to calculate and assess the carbon footprint of leather product. This helps transition of the leather making industry to green and economic sustainable development, and gradually removes the obstacle of the environmental protection barrier that may be encountered in future leather export for earning foreign exchange.

The life circle assessment method is an assessment tool for calculating and assessing the influence of a product or service on the environment in an entire life cycle thereof. At present, the life circle assessment method has been widely applied to carbon footprint analysis in the fields of buildings, steels, and the like. The process in the leather making industry is complex. More than 4000 chemicals are used in leather production, and most of chemicals are exclusively used for leather production. The production process of these chemicals is complex, which usually needs to be used in a specific combination manner. In order to calculate the carbon footprint of leather product in a life cycle thereof, the carbon footprint of a used leather chemical materials needs to be known. At present, there is no unified framework for the calculation of the carbon footprint of leather chemical materials in China, and there is also no standardized life cycle inventory analysis method, including the determination of a system boundary, a standard of data selection, the establishment of a calculation model, and the like. Therefore, an approximate substitution method for chemicals is usually used in life cycle assessment on leather product in China. This results in inaccurate carbon footprint calculation of leather products in China and is not conducive to green and low carbon development of the leather making industry.

At present, there are very few studies on carbon footprint calculation of chemical materials for leather. How to establish a framework for life cycle assessment of chemical materials for leather and accurately calculate the carbon footprint of leather chemical materials has practical significance and practical value for accurate calculation of leather product carbon footprint, reducing resource and energy consumption, and realizing green, low carbon and sustainable development in the leather making industry. In order to solve the above problems, the present disclosure is intended to provide a method for calculating the carbon footprint of leather chemical materials. In combination with the production practice of and deep analysis on chemical materials for leather, a framework and method for calculating the carbon footprint of leather chemical materials is established for accurately calculating and assessing carbon footprints of chemical materials for leather.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a method for calculating a carbon footprint of a leather chemical material including following steps.
(1) A calculation range of a carbon footprint of a leather chemical material in a life cycle is determined as “cradle to gate”, i.e., a carbon footprint from obtaining a raw material of the leather chemical material to obtaining a finished product upon the completion of production is calculated.
(2) A system boundary, a functional unit, and cut-off criteria for the carbon footprint of the leather chemical material in the life cycle are determined; the carbon footprint of the leather chemical material is divided into a raw chemical obtaining process, a production process of the leather chemical material, and a waste disposal process within the system boundary; and the functional unit is defined as production of 1 kg leather chemical material.
(3) A carbon footprint calculation model is established according to resource consumption and environmental emission of each process, i.e., an input and an output of each process are collected according to the production process of the leather chemical material, and inventory analysis is performed on the carbon footprint of the leather chemical material in the life cycle.

The carbon footprint calculation model for the raw chemical obtaining process uses Formula (1) for calculation:

$${E}_{i} = {E}_{i 1} + {E}_{i 2} \qquad ( 1 )$$

Here:
Eᵢ represents a carbon footprint of the obtaining process of an ith raw chemical needed by the leather chemical material, in units of kgCO₂;
Eᵢ₁ represents a carbon footprint of a raw material needed for producing the ith raw chemical, in units of kgCO₂; and
Eᵢ₂ represents a carbon footprint of an energy source used for producing the ith raw chemical, including, but not limited to, electric energy, thermal energy, and a fuel consumed by unit operations in production, in units of kgCO₂.

The carbon footprint of the raw material is calculated by Formula (2):

$${E}_{i 1} = \sum {m}_{x} * {E}_{x} \qquad ( 2 )$$

Here:
mₓ is a mass of an xth raw material, in units of kg; and
Eₓ represents the carbon footprint corresponding to the xth raw material, which is mainly obtained by actual measurement or from second hand data, in units of kgCO₂/kg.

The carbon footprint of the energy source is calculated by Formula (3):

$${E}_{i 2} = \sum {E}_{e i} \qquad ( 3 )$$

Here:
Eₑᵢ represents the carbon footprint of the energy source used in a raw chemical production process, including, but not limited to, electric energy, thermal energy, and a fuel consumed by unit operations in production, in units of kgCO₂.

The carbon footprint calculation model for the production process of the leather chemical material uses Formula (4) for calculation:

$${E}_{m} = {E}_{e} + \sum {a}_{i} * {E}_{i} \qquad ( 4 )$$

Here:
Eₘ represents a total carbon footprint of the production process of the leather chemical material, in units of kgCO₂;
Eₑ represents a carbon footprint of an energy source used for producing the leather chemical material, including, but not limited to, electric energy, thermal energy, and a fuel consumed by unit operations of producing the leather chemical material, in units of kgCO₂; and
αᵢ represents a mass of the ith raw chemical needed for producing the leather chemical material, in units of kg.

The carbon footprint calculation model for the waste disposal process uses Formula (5) for calculation:

$${E}_{w} = \sum {E}_{wi} \qquad ( 5 )$$

Here:
E_{w} represents a total carbon footprint of disposing all generated wastes, in units of kgCO₂; and

E_{wi} represents a carbon footprint of disposing a waste generated by each unit operation in production, in units of kgCO₂.

Finally, a calculation result of the carbon footprint of the leather chemical material by Formula (6) is expressed as:

$$E = ( {E}_{m} + {E}_{w} ) / M \qquad ( 6 )$$

Here:
E represents the carbon footprint of the leather chemical material, in units of kgCO₂/kg; and
M represents an output mass of the leather chemical material in inventory analysis, in units of kg.
(4) Data verification is performed on the established calculation models; accuracy and validity of data are verified according to mass conservation; and a calculation method, an allocation program, a data requirement, and an emission factor in each process are determined.
(5) After the carbon footprint of the leather chemical material is calculated using the carbon footprint calculation model, integrity, consistency, and sensitivity analysis is performed; the carbon footprint result and data quality are assessed, and a conclusion is drawn.

The leather chemical material includes, but is not limited to, chemical materials serving to turn “raw hide” into “leather”, namely a soaking agent, a bating enzyme, a chrome tanning agent, an amino resin tanning agent, a fat liquoring agent, and a finishing agent.

The energy source input in the production process of the leather chemical material includes, but is not limited to, energy sources consumed by production operations of reaction, condensation, extraction, washing, distillation, filter pressing, drying, stirring, and cleaning for the leather chemical material in a reaction kettle under specific conditions.

The cut-off criteria are in the production of the leather chemical material, if a usage amount of a raw chemical is less than or equal to 1% of a total output weight of the leather chemical material in inventory analysis, skipping considering the input of the raw chemical, where a total weight of neglected raw chemicals does not exceed 5% of the total output weight.

When a calculation model for the carbon footprint of the leather chemical material in the life cycle is established, carbon footprint data of a raw material needs to be actually measured; and if data measurement is failed, representative or authoritative secondhand data from a database or a related document is used.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

In some embodiments, the disclosure provides a method for calculating a carbon footprint of a waterborne polyurethane finishing agent may include the following steps.
(1) A calculation range of a carbon footprint of the waterborne polyurethane finishing agent in a life cycle is determined as “cradle to gate”, i.e., a carbon footprint from obtaining a raw material of the waterborne polyurethane finishing agent to obtaining a finished product upon the completion of production is calculated.
(2) A system boundary, a functional unit, and cut-off criteria for the carbon footprint of the waterborne polyurethane finishing agent in the life cycle are determined; the carbon footprint of the waterborne polyurethane finishing agent is divided into a raw chemical obtaining process, a production process of the waterborne polyurethane finishing agent, and a waste disposal process within the system boundary; and the functional unit is defined as production of 1 kg waterborne polyurethane finishing agent. The cut-off criteria are in the production of the waterborne polyurethane finishing agent, if a usage amount of a raw chemical is less than or equal to 1% of a total output weight of the waterborne polyurethane finishing agent in inventory analysis, skipping considering the input of the raw chemical, where a total weight of neglected raw chemicals does not exceed 5% of the total output weight.
(3) A carbon footprint calculation model is established according to resource consumption and environmental emission of each process, i.e., an input and an output of each process are collected according to the production process of the waterborne polyurethane finishing agent, and inventory analysis is performed on the carbon footprint of the waterborne polyurethane finishing agent in the life cycle, where the energy source input in the production process of the leather chemical material may include, but is not limited to, energy sources consumed by production operations of reaction, condensation, extraction, washing, distillation, filter pressing, drying, stirring, and cleaning for the waterborne polyurethane finishing agent in a reaction kettle under specific conditions.

The carbon footprint calculation model for the raw chemical obtaining process uses Formula (1) for calculation:

$${E}_{i} = {E}_{i 1} + {E}_{i 2} \qquad ( 1 )$$

Here:
Eᵢ represents a carbon footprint of the obtaining process of an ith raw chemical needed by the leather chemical material, in units of kgCO₂;
Eᵢ₁ represents a carbon footprint of a raw material needed for producing the ith raw chemical, in units of kgCO₂; and
Eᵢ₂ represents a carbon footprint of an energy source used for producing the ith raw chemical, including, but not limited to, electric energy, thermal energy, and a fuel consumed by unit operations in production, in units of kgCO₂.

The carbon footprint of the raw material is calculated by Formula (2):

$${E}_{i 1} = \sum {m}_{x} * {E}_{x} \qquad ( 2 )$$

Here:
mₓ is a mass of an xth raw material, in units of kg; and
Eₓ represents the carbon footprint corresponding to the xth raw material, which is mainly obtained by actual measurement or from second hand data, in units of kgCO₂/kg.

The carbon footprint of the energy source is calculated by Formula (3):

$${E}_{i 2} = \sum {E}_{e i} \qquad ( 3 )$$

Here:
Eₑᵢ represents the carbon footprint of the energy source used in a raw chemical production process, including, but not limited to, electric energy, thermal energy, and a fuel consumed by unit operations in production, in units of kgCO₂.

The carbon footprint calculation model for the production process of the leather chemical material uses Formula (4) for calculation:

$${E}_{m} = {E}_{e} + \sum {a}_{i} * {E}_{i} \qquad ( 4 )$$

Here:
Eₘ represents a total carbon footprint of the production process of the leather chemical material, in units of kgCO₂;
Eₑ represents a carbon footprint of an energy source used for producing the leather chemical material, including, but not limited to, electric energy, thermal energy, and a fuel consumed by unit operations of producing the leather chemical material, in units of kgCO₂; and
aᵢ represents a mass of the ith raw chemical needed for producing the leather chemical material, in units of kg.

The carbon footprint calculation model for the waste disposal process uses Formula (5) for calculation:

$${E}_{w} = \sum {E}_{wi} \qquad ( 5 )$$

Here:
E_{w} represents a total carbon footprint of disposing all generated wastes, in units of kgCO₂; and
E_{wi} represents a carbon footprint of disposing a waste generated by each unit operation in production, in units of kgCO₂.

Finally, a calculation result of the carbon footprint of the leather chemical material by Formula (6) is expressed as:

$$E = ( {E}_{m} + {E}_{w} ) / M \qquad ( 6 )$$

Here:
E represents the carbon footprint of the leather chemical material, in units of kgCO₂/kg; and
M represents an output mass of the leather chemical material in inventory analysis, in units of kg.
(4) Data verification is performed on the established calculation models; accuracy and validity of data are verified according to mass conservation; and a calculation method, an allocation program, a data requirement, and an emission factor in each process are determined.
(5) After the carbon footprint of the leather chemical material is calculated using the carbon footprint calculation model, integrity, consistency, and sensitivity analysis is performed; the carbon footprint result and data quality are assessed, and a conclusion is drawn.

Optionally, present disclosure establishes the system boundary for calculating the carbon footprint of the leather chemical material using the life cycle assessment method, and the life cycle processes are divided according to production characteristics. Inventory data is collected, and the carbon footprint calculation model is established. Finally, the carbon footprint of the leather chemical material is calculated. This has practical significance and practical value for establishing the exclusive database of carbon footprints of chemical materials for leather, accurately calculating a carbon footprint of a leather product in the leather making industry, reducing resource and energy consumption in leather making, and realizing green low carbon sustainable development.

Various embodiments of the disclosure may have one or more of the following effects. In some embodiments, the disclosure may provide a method for calculating a carbon footprint of a leather chemical material. With regard to the production practice of chemical materials for leather, the framework for life cycle assessment of chemical materials for leather may be established, and a carbon footprint of a leather chemical material may be accurately calculated. In other embodiments, the use of the method for calculating a carbon footprint proposed in the disclosure may have practical significance and practical value for establishing an exclusive database of carbon footprints of chemical materials for leather, accurately calculating a carbon footprint of a leather product, reducing resource and energy consumption in leather making, and realizing green low carbon and sustainable development.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various FIGURES need be carried out in the specific order described.

The disclosure claimed is:

1. A method for calculating a carbon footprint of a leather chemical material, comprising:
(1) determining a calculation range of a carbon footprint of a leather chemical material in a life cycle as “cradle to gate”, namely calculating a carbon footprint from obtaining a raw material of the leather chemical material to obtaining a finished product upon completion of production;
(2) determining a system boundary, a functional unit, and cut-off criteria for the carbon footprint of the leather chemical material in the life cycle, dividing the carbon footprint of the leather chemical material into a raw chemical obtaining process, a production process of the leather chemical material, and a waste disposal process within the system boundary, and defining the functional unit as production of 1 kg leather chemical material;
(3) establishing a carbon footprint calculation model according to resource consumption and environmental emission of each process, namely collecting an input and an output of each process according to the production process of the leather chemical material, and performing inventory analysis on the carbon footprint of the leather chemical material in the life cycle;
wherein:
the carbon footprint calculation model for the raw chemical obtaining process uses Formula (1) for calculation:
$${E}_{i} = {E}_{i 1} + {E}_{i 2} , \qquad ( 1 )$$
wherein:
Eᵢ represents a carbon footprint of the obtaining process of an ith raw chemical needed by the leather chemical material, in units of kgCO₂;
Eᵢ₁ represents a carbon footprint of a raw material needed for producing the ith raw chemical, in units of kgCO₂; and
Eᵢ₂ represents a carbon footprint of an energy source used for producing the ith raw chemical, comprising, but not limited to, electric energy, thermal energy, and a fuel consumed by unit operations in production, in units of kgCO₂;
the carbon footprint of the raw material is calculated by Formula (2):
$${E}_{i 1} = \sum {m}_{x} * {E}_{x} , \qquad ( 2 )$$
wherein:
mₓ is a mass of an xth raw material, in units of kg; and
Eₓ represents the carbon footprint corresponding to the xth raw material, which is mainly obtained by actual measurement or from second hand data, in units of kgCO₂/kg;
the carbon footprint of the energy source is calculated by Formula (3):
$${E}_{i 2} = \sum {E}_{e i} , \qquad ( 3 )$$
wherein Eₑᵢ represents the carbon footprint of the energy source used in a raw chemical production process, comprising, but not limited to, electric energy, thermal energy, and a fuel consumed by unit operations in production, in units of kgCO₂;
the carbon footprint calculation model for the production process of the leather chemical material uses Formula (4) for calculation:
$${E}_{m} = {E}_{e} + \sum {a}_{i} * {E}_{i} , \qquad ( 4 )$$
wherein:
Eₘ represents a total carbon footprint of the production process of the leather chemical material, in units of kgCO₂;
Eₑ represents a carbon footprint of an energy source used for producing the leather chemical material, comprising, but not limited to, electric energy, thermal energy, and a fuel consumed by unit operations of producing the leather chemical material, in units of kgCO₂; and
aᵢ represents a mass of the ith raw chemical needed for producing the leather chemical material, in units of kg;
the carbon footprint calculation model for the waste disposal process uses Formula (5) for calculation:
$${E}_{w} = \sum {E}_{wi} , \qquad ( 5 )$$
wherein:
E_{w} represents a total carbon footprint of disposing all generated wastes, in units of kgCO₂; and
E_{wi} represents a carbon footprint of disposing a waste generated by each unit operation in production, in units of kgCO₂; and
a calculation result of the carbon footprint of the leather chemical material by Formula (6) is expressed as:
$$E = ( {E}_{m} + {E}_{w} ) / M , \qquad ( 6 )$$
wherein:
E represents the carbon footprint of the leather chemical material, in units of kgCO₂/kg; and
M represents an output mass of the leather chemical material in inventory analysis, in units of kg;
(4) performing data verification on the established calculation models, verifying accuracy and validity of data according to mass conservation, and determining a calculation method, an allocation program, a data requirement, and an emission factor in each process; and
(5) after the carbon footprint of the leather chemical material is calculated using the carbon footprint calculation model, performing integrity, consistency, and sensitivity analysis, assessing the carbon footprint result and data quality, and drawing a conclusion.

2. The method according to claim 1, wherein:
the leather chemical material comprises a chemical material serving to turn “raw hide” into “leather”; and
the chemical material comprises at least one item selected from the group consisting of a soaking agent, a bating enzyme, a chrome tanning agent, an amino resin tanning agent, a fat liquoring agent, and a finishing agent.

3. The method according to claim 1, wherein the energy source input in the production process of the leather chemical material comprises energy sources consumed by production operations of reaction, condensation, extraction, washing, distillation, filter pressing, drying, stirring, and cleaning for the leather chemical material in a reaction kettle.

4. The method according to claim 1, wherein the cut-off criteria are:
in the production of the leather chemical material, if a usage amount of a raw chemical is less than or equal to 1% of a total output weight of the leather chemical material in inventory analysis, skip considering the input of the raw chemical; and
a total weight of neglected raw chemicals does not exceed 5% of the total output weight.

5. The method according to claim 1, wherein:
when a calculation model for the carbon footprint of the leather chemical material in the life cycle is established, carbon footprint data of a raw material is measured; and
if data measurement is failed, representative or authoritative secondhand data from a database or a related document is used.
